(19) United States
(12) Patent Application Publication
(10) Pub. No.: US 2007/0069045 A1
(43) Pub. Date: Mar. 29, 2007

(54) Ejector of a mixture of air and water for hydromassage baths

(76) Inventor: Alessandro Moretto, Pordenone (IT)

Correspondence Address: AMERICAN STANDARD INC., ONE CENTENNIAL AVENUE, PISCATAWAY, NJ, 08855-6820, US

(21) Appl. No.: 11/589,365

(22) Filed: Oct. 30, 2006

(30) Foreign Application Priority Data
May 19, 2004 (IT) RE2004AO00057

(51) Int. Cl. B05B 7/30; B05B 7/06

(52) U.S. Cl. 239/318; 239/424; 239/428.5

(57) ABSTRACT

An Ejector (1) of a mixture of air and water for hydromassage baths (100), comprising a first inner collector (2) provided with at least one opening for supplying pressurised water and a second outer collector (3) arranged coaxially to said inner collector (2) so as to form an annular air chamber, said first collector (2) and second collector (3) being connected together through at least one ejector nozzle (10) of said mixture of air and water.

The present invention refers to an ejector of a mixture of air and water for hydromassage baths in accordance with the preamble of claim 1.

More specifically, the present invention refers to an ejector of a mixture of air and water suitable for being applied and for functioning above the free surface of the water present in a bath creating the hydromassage effect. As known, hydromassage baths comprise a basin equipped, on the walls, with multiple jets fed by a pump unit that takes water from the basin itself, filled previously, and sends it back, under pressure, possibly mixed with air, into the basin through suitably shaped nozzles.

In baths of the prior art, the jets remain totally submerged in the water present in the basin of the bath during hydromassage.

Therefore, attention has always been focused upon preventing water leakage from the basin into the jets themselves through the use of devices suitable for preventing said leaking with more or less complex constructive solutions.

Therefore, there is a great need for an ejector of a mixture of air and water for hydromassage baths that is arranged above the level of the water present in the basin of the bath and that manages to easily and effectively create the hydromassage effect.

Subordinately, the ejector must also function when partially submerged, it must be simple and quick to replace and/or repair, it must be of modest constructive difficulty and it must be able to be applied to baths of the prior art, as well as have properties of Modularity and be able to be used as a hand-grip to help the user who must enter and leave the bath.

The purpose of the present invention is that of providing an ejector of a mixture of air and water for hydromassage baths having structural and functional characteristics such as to satisfy the aforementioned requirements and at the same time to avoid the aforementioned drawbacks with reference to the prior art.

Such a purpose is accomplished through an ejector of a mixture of air and water for hydromassage baths in accordance with claim 1.

The dependent claims outline preferred and particularly advantageous embodiments of the ejector for hydromassage baths according to the invention.

Further characteristics and advantages of the invention shall become clear from reading the following description provided as an example and not for limiting purposes, with the help of the figures illustrated in the attached tables, in which:

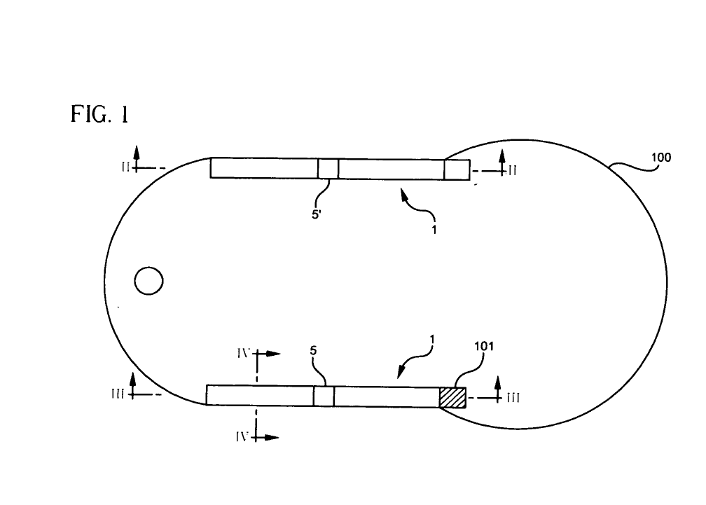

FIG. 1 shows a schematic view from above of ejectors according to the present invention, assembled together and applied to a hydromassage bath;

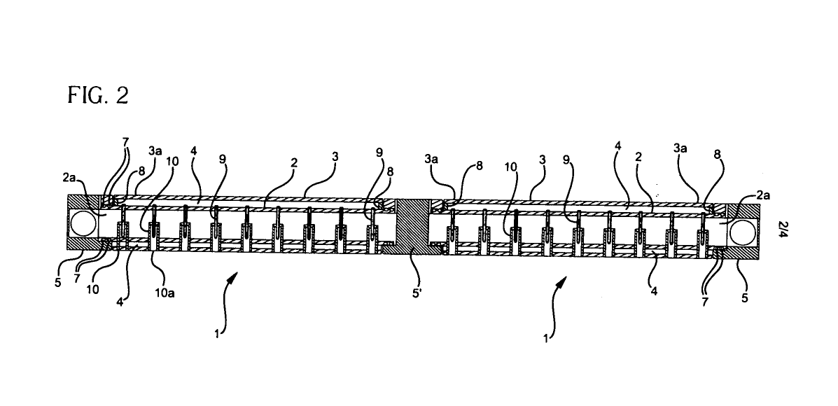

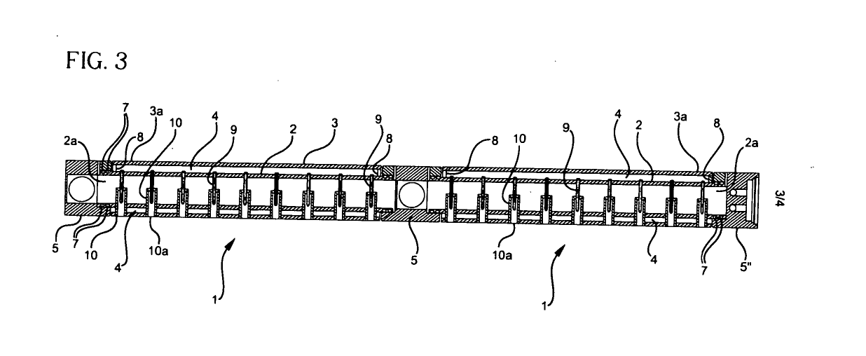

FIGS. 2 and 3 show a section view taken along the plane II-II and III-III of FIG. 1, respectively;

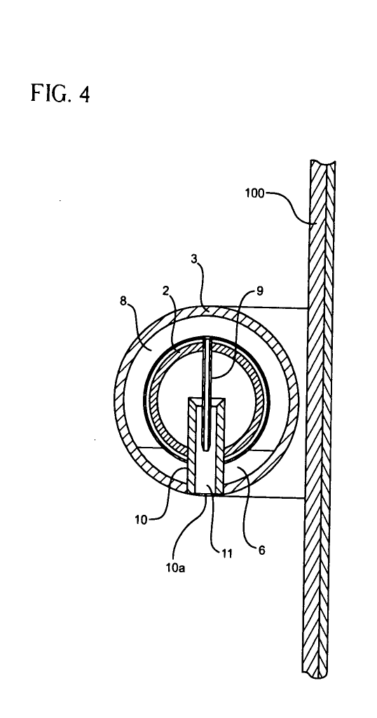

FIG. 4 shows a section view taken along the plane IV-IV of FIG. 1.

With reference to the aforementioned figures, an ejector of a mixture of air and water for hydromassage baths in accordance with the present invention is globally indicated with 1.

In the use schematised in FIG. 1, two pairs of ejectors 1 are assembled together arranged opposite one another on side edges of a conventional bath 100.

Moreover, one of the two pairs of ejectors 1 is provided with a thermostatic mixer 101 (FIG. 1.), known in the field and for the sake of simplicity not shown any further in the subsequent figures.

In the rest of the description, the parts that are structurally equivalent to each other shall be indicated on the drawings with the same reference numerals. Moreover, for the sake of brevity of explanation, they shall be described only once.

In accordance with the preferred embodiment of the present invention, the ejector 1 comprises a first inner collector 2 and a second outer collector 3 arranged coaxially to the inner collector so as to form an annular air chamber 4.

This can be ensured by the presence of a slot on the edge of the seats of the heads 5 in which a guide projecting from the inner collector 2, not illustrated, slides, always ensuring a seal.

In order to ensure the centring between the outer collector 3 and the inner collector 2 a split centring washer 8 is placed at the two ends 3a of the outer collector.

The use of the split washer 8 allows an opening 6 to be left free on both of the opposite sides of the outer collector 3 in order to allow the entry of air from the outside into the annular chamber 4, as can clearly be seen in FIG. 4.

The ejector nozzles 10 of the mixture of air and water are arranged aligned.

Nevertheless, a different arrangement of the nozzles can be foreseen according to ones own needs, like for example along a zigzagging line.

A tube 9 communicating with the annular chamber 4 for air intake is arranged inside the ejector nozzle 10 extending inside the nozzle 10 for a portion smaller than 10 the length of the nozzle itself.

Basically, the air intake present in the annular chamber 4 takes place by Venturi effect caused by the pressurised water that crosses the nozzle 10.

The mixing of air and water takes place in the nozzle 10 and, to be precise, in the zone 11 (FIG. 4) present between the end of the tube 9 inserted in the nozzle 10 and the ejection hole 10a.

In the illustrated example, the ejector 1 is assembled in pairs, the pair shown in FIG. 2 having the supply ducts for pressurised water associated with the side heads 5, whilst the central head 5′ is blind.

The pair shown in FIG. 3 has the supply ducts for pressurised water respectively associated with the central head 5 and with one of the side heads 5, whereas the supply duct for the water coming from the water mains suitably mixed with hot water through the mixer that is only shown, for the sake of simplicity, in FIG. 1 is associated with the remaining side head 5″.

An attachment bracket for fastening the ejectors 1 to the inner walls of the bath 100 is associated with each head 5. In the example, the brackets are manufactured in a single piece with the respective heads 5.

Operatively, the basin of the bath 100 is filled with water coming from the water mains through the use of the mixer.

Once filling is complete, usually to just below the ejector 1, the hydromassage function according to the prior art is activated.

The pressurised water, made to circulate by a suitable pump group, crosses the inner collector 2 to go out through the nozzles 10.

The passage of the pressurised water through the nozzles 10 causes, by Venturi effect, the intake by the tubes 9 of air that mixes with the water before being ejected from the hole 10a of the nozzle 10 creating the hydromassage effect.

As can be appreciated from that which has been described, the ejector of a mixture of air and water for hydromassage baths according to the present invention allows the requirements to be satisfied and allows the drawbacks mentioned in the introductive part of the present description with reference to the prior art to be overcome. Indeed, said ejector allows the hydromassage effect to be created without being immersed in water.

Moreover, the ejector of the present invention can also be used for the initial filling of the bath avoiding the use of an additional tap.

The possibility of assembling many ejectors modularly as desired with a substantially aesthetically pleasing final look and the use of the ejector as a handgrip to help the user who must enter and exit the bath are substantial advantages.

Of course, a man skilled in the art can bring numerous modifications and variants to the ejector of a mixture of air and water for hydromassage baths described above in order to satisfy contingent and specific requirements, all of these modifications in any case being covered by the scope of protection of the invention, as defined by the following claims.

1. Ejector (1) of a mixture of air and water for hydromassage baths (100), characterised in that it comprises a first inner collector (2) provided with at least one opening for supplying pressurised water and a second outer collector (3) arranged coaxially to said inner collector (2) so as to form an annular air chamber, said first collector (2) and second collector (3) being connected together through at least one ejector nozzle (10) of said mixture of air and water.

2. Ejector (1) according to claim 1, wherein a split centring washer (8) is placed between the outer collector (3) and the inner collector (2) at the two opposite ends (3a).

3. Ejector (1) according to claim 1 comprising a plurality of nozzles (10) arranged aligned.

4. Ejector (1) according to claim 1, wherein a tube (9) communicating with said annular chamber (4) for air intake is arranged coaxially inside said ejector nozzle (10).

5. Ejector (1) according to claim 1, wherein said annular chamber (4) is in communication with the outside.

6. Ejector (1) according to claim 1 associated with two opposite heads (5) suitable for being fixed to the wall of a basin of the bath (100).
